(19) United States
(12) Patent Application Publication
(10) Pub. No.: US 2004/0257814 A1
(43) Pub. Date: Dec. 23, 2004

(54) Floor lamp assembly with night-light having improved dimmer configuration

(76) Inventor: Paul Eusterbrock, St. Paul, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/872,292

(22) Filed: Jun. 18, 2004

Related U.S. Application Data
(60) Provisional application No. 60/480,577, filed on Jun. 20, 2003.

(51) Int. Cl. G05F 1/00

(52) U.S. Cl. 362/276

(57) ABSTRACT

A freestanding lamp having an attractively hidden dimmer switch located at a point between the base of the lamp and the primary light source. The location of the dimmer switch allows a user to operate the lamp without bending over and without coming into close proximity to the primary light source. The freestanding lamp includes a secondary lamp located between the base and the primary lamp. The secondary lamp is useable as a night-light and may be equipped with a light sensor and/or dimmer switch.

### CROSS REFERENCE TO RELATED APPLICATIONS

This application claims priority from provisional application No. 60/480,577 filed Jun. 20, 2003 and entitled, FLOOR LAMP ASSEMBLY WITH NIGHTLIGHT HAVING IMPROVED DIMMER CONFIGURATION.

### BACKGROUND OF THE INVENTION

In the field of lighting fixtures, it is a commonly accepted and efficient practice to utilize dimmer switches in order to vary the intensity of light produced. The use of a dimmer switch, however, often complicates design possibilities as the dimmer itself is often a relatively large component, which must be placed somewhere in the light fixture.

With floor lamps, there is a need for a fairly substantial base portion that supports the remainder of the floor lamp. As can be appreciated, this base portion must have a substantial dimension so that forces can be appropriately distributed, while also having sufficient weight to stabilize the floor lamp. Due to these already existing requirements, the base portion is a very convenient spot to house the dimming switch mechanism. Further, while placing the dimming switch in the base itself, several design options are preserved.

From the design prospective, it has often been difficult to provide a dimmer switch location other than the base. Often there is a desire for sleek, non-bulky supporting posts and the inclusion of large housings or large structures within or on these posts is very undesirable. Furthermore, the placement of the dimmer near the bulb itself is often undesirable as it is not easily accessible to the user. In addition, excessive heat produced by the bulb can adversely affect the life expectancy of the dimmer switch.

Placing the dimmer switch at an intermediate location along the post of the lamp is often ideal as this position is accessible by a user who is either seated or standing. In the past, one approach to achieve this dimmer switch placement is to provide a switch or knob having a long connecting rod that extends down to the base. This long rod then connects with the actual dimming switch electronics and mechanisms in order to achieve an operable dimming mechanism. This configuration allows the electronics of the dimming switch mechanism to be contained within the base while also providing accessibility. As can be appreciated however, the existence of a long actuating arm or rod creates additional complications. Specifically, the rod must be supported and structured to contain all additional forces which may be generated. Further, the actuating rod must transfer forces to the dimming switch, which may include large amounts of torque along the rod's length.

Furthermore, the placement of the dimmer housing at an intermediate and elevated location along the main lamppost allows for an easy attachment point for an additional lighting source. Although there are various floor lamp constructions, which incorporate one or more reading lamp fixtures permanently mounted at various heights along the vertical post of the floor lamp, most floor lamps do not include any provision for including a night-light type of capability. For purposes of assisting family members and guests navigating their way through corridors and rooms in the darkness, a wide variety of night-lights have been proposed, however, most night-lights are adapted for use with an electrical outlet in the wall and most only illuminate the “path” of the user. While these conventional night-lights are popular with some users, others choose not to use them for various reasons including lack of electrical outlets available for these conventional plug-in type night-lights. Also, conventional plug-in night-lights substantially limit the range of the beam of light, as well as taking up an electrical outlet. As a result, such the use of such night-lights are often limited to hallways and unprotected areas where they are likely to be kicked or removed by small children or household pets, especially since many excessively protrude from the wall.

Further, often night-lights are not provided with the option for multiple levels of illumination. Sometimes even at a night-light's lowest setting, the illumination is too bright to a user whose eyes have not yet adjusted to the light. These night-lights do not provide the user with varying levels of illumination, which would allow the user to adjust the lighting as they adjusted to the light.

### BRIEF SUMMARY OF THE INVENTION

In order to achieve an aesthetically pleasing floor lamp design, while also providing the desired functionality, the floor lamp of the present invention includes a dimmer switch at a mid-point of the supporting post in order to allow maximum accessibility for the users. Further, the present invention provides for a night-light attached to the floor lamp, which provides for a broad beam of low lighting.

The dimmer switch is contained within a compact and aesthetically pleasing dimmer housing, and is appropriately connected via electrical connections that extend through the main supporting post. By utilizing the dimmer switch in this location, the need for mechanical connecting rods is eliminated. Further, the placement of the dimmer housing at an intermediate and elevated location along the main lamppost allows for an easy attachment point for an additional lighting source. Also, additional design freedom is obtained.

While elimination of a feature such as a mechanical connecting rod can be obtained, the similar feature could also be utilized from a design perspective, even using the lamp of the present invention. That is, this feature could be included as a non-functional aesthetic feature.

One advantage of the invention is the convenient placement of the dimmer switch in conjunction with the design flexibility afforded. Further, the need for a functional actuating rod is eliminated.

Another advantage of this invention is the addition of a night-light to a floor lamp, wherein the night-light emits a relatively broad beam of light that illuminates a broad area of the room.

Another advantage of this invention is to provide a night-light with the option of multiple levels of illumination.

Another advantage of this invention is to provide a night-light attached to a swing arm of the floor lamp, thereby allowing movement of the night-light by the user to selectively aim the beam of light.

Yet another advantage of this invention is to provide a floor lamp that includes both a conventional light source and a low wattage light source.

Another advantage of this invention is to provide a night-light that is elevated, thereby illuminating more than just a “path” of light.

This invention allows the night-light's light source to be LED, low-voltage halogen, traditional incandescent, electroluminescent, or any other type of lighting now known or later developed.

In one embodiment, the night-light may be activated by a light sensor, allowing for the night-light to automatically illuminate when the room reaches a predetermine level of darkness.

In another embodiment, the night-light may automatically turn off when the main lighting source of the floor lamp is turned on.

In another embodiment, the night-light may be set to a time, thereby allowing the user to program the timing of the activation of the night-light.

### BRIEF DESCRIPTION OF THE DRAWINGS

FIG. 1 is a perspective view of one embodiment of a floor lamp having the improvements of the present invention;

FIG. 2 is a side view of the floor lamp shown in FIG. 1;

FIG. 3 is a rear view of the floor lamp shown in FIG. 1;

FIG. 4 is a front view of the floor lamp shown in FIG. 1;

FIG. 5 is a top view of the floor lamp shown in FIG. 1; and,

FIG. 6 is a bottom view of the floor lamp shown in FIG. 1.

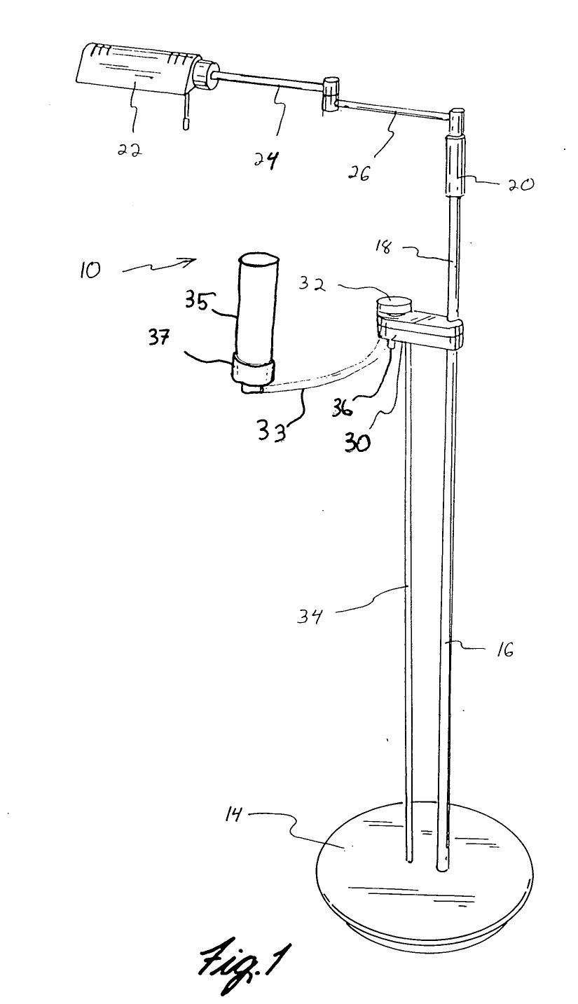

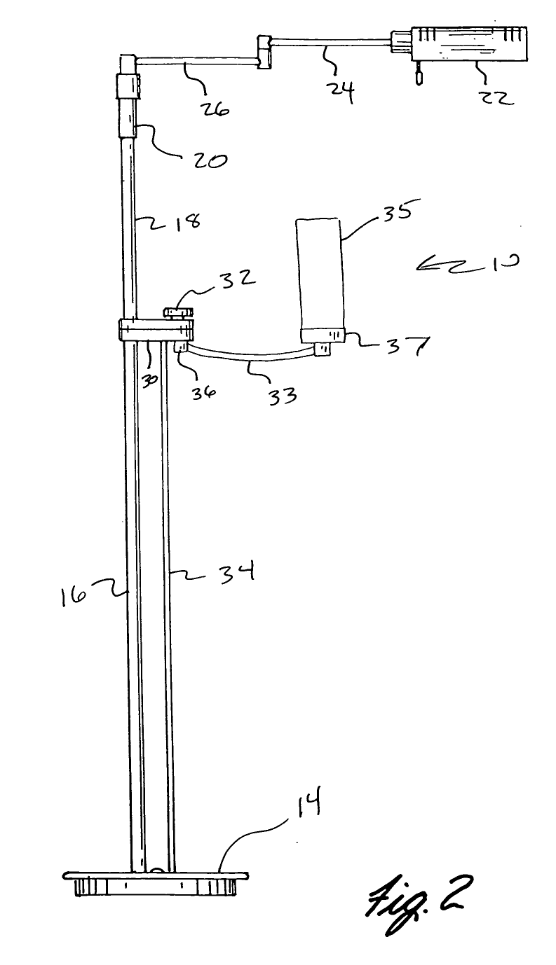

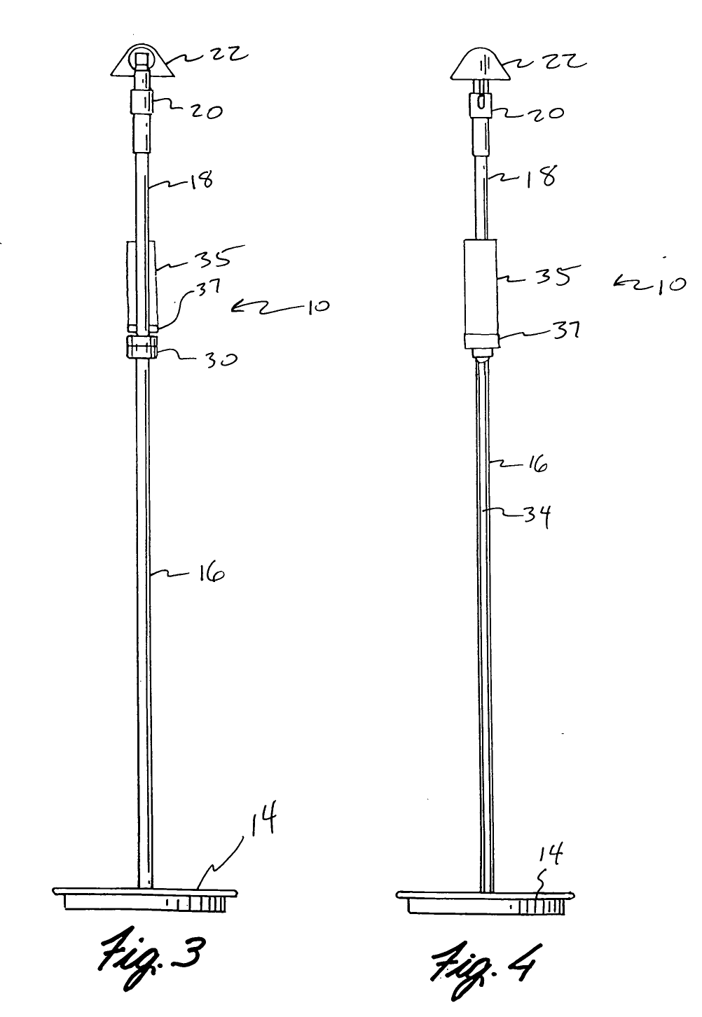

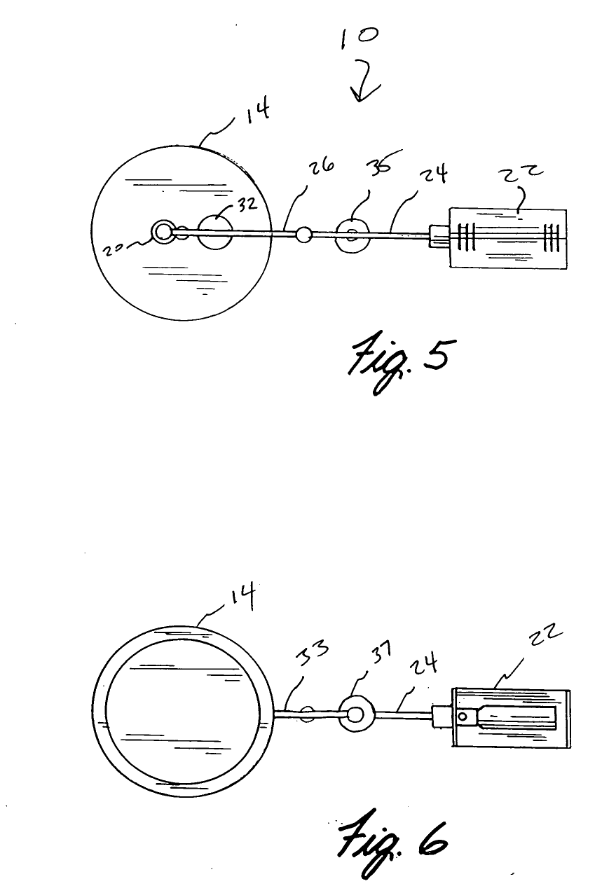

### DETAILED DESCRIPTION OF THE INVENTION

Referring now to the Figures, which illustrate one embodiment of the present invention, a floor lamp 10 is shown having the desired features of the present invention. More specifically, the floor lamp 10 includes a base portion 14 along with a first supporting post 16, extending upwardly therefrom. Naturally, an electrical connecting cord would provide operating power to the floor lamp 10. The first supporting post 16 has a second supporting post 18 and a connecting element 20. In this particular embodiment, the second supporting post is adjustable thereby allowing the height of the floor lamp to be adjusted upwardly and downwardly. In this particular embodiment, a lampshade assembly 22 and a pair of swing arms 24 and 26 are attached to the second supporting post 18. As will be appreciated, within the lampshade assembly 22 is the lighting socket and light bulb, which provides the light source (not shown).

Attached to the main supporting post 16 is dimmer housing 30 and a first dimmer knob 32. The dimmer housing 30 contains the dimmer switch, which provides dimming capabilities to the lamp. Extending downwardly from dimmer housing 30 is a third supporting post 34, which provides additional structural stability to this particular floor lamp. The dimming functionality is contained within dimmer housing 30, thus the third supporting rod 34 is purely structural and aesthetic in nature.

Attached to the base of the dimmer housing 30, is a swing arm 33, which attaches to the base unit 37 of a night-light 35. A second dimmer knob 36, which provides dimming capabilities to the night-light 35, is located on the underside of the dimmer housing 30. It will appreciated that all types of design possibilities could be achieved utilizing this design.

As mentioned above, the dimmer housing 30 accommodates first dimmer knob 32 and second dimmer knob 36. Both of these knobs are attached to cooperating dimmer switches, both of which are housed within dimmer housing 30. Due to the size of such switch mechanisms, this type of configuration has not previously been possible. This is especially true when the dimmer housing 30 has a relative size of roughly 3 inches by 2 inches by 2 inches. This particularly provides design advantages. More specifically, the dimmer mechanisms can be placed in a space that is much smaller than previously required. This allows dimmer housing 30 to be stylish and reasonably sized.

In addition to the size of the dimmer housing, the embodiment shown in the figures has the ability to place first dimmer knob 32 directly above the third supporting post 34. In this configuration, it has the appearance of a long-extending control rod attached to dimmer knob 32. Naturally, this long extending control rod is not actually required, thus avoiding complications related to such dimmer control mechanisms.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments, which have been described in detail therein. Rather, reference should be made to the appended claims as indicative of the scope and content of the present invention.

What is claimed is:

1. A freestanding lamp comprising:
a base;
an electrical cord extending from the base and having a plug at a distal end thereof connectable to a power source;
at least one support post having an upper end and a lower end, the lower end operably connected to the base;
a first light source attached to the upper end of the at least one support post;
a first dimmer switch in electrical continuity with the first light source for varying a voltage to the first light source, the first dimmer switch contained within a housing operably connected to the at least one support post at a location between the upper end and the lower end of the at least one support post.

2. The freestanding lamp of claim 1 further comprising a second light source operably connected to the at least one support post at a location between the upper end and the lower end.

3. The freestanding lamp of claim 2 further comprising a second dimmer switch, the second dimmer switch in electrical continuity with the second light source for varying a voltage to the second light source, the second dimmer switch contained within a housing operably connected to the at least one support post at a location between the upper end and the lower end.

4. The freestanding lamp of claim 2 further comprising a light sensor, operably connected to the second light source, for causing the second light source to be illuminated when an ambient light level drops below a predetermined level.

5. The freestanding lamp of claim 2 further comprising a switch in electrical continuity with the second light source for providing a plurality of voltage levels to the second light source.

6. The freestanding lamp of claim 2 further comprising a swing arm operably coupling the second light source to the at least one support post.

7. The freestanding lamp of claim 2 wherein said second light source comprises a low-wattage light source useable as a night light.

8. The freestanding lamp of claim 7 wherein said second light source comprises a light emitting diode.

9. The freestanding lamp of claim 7 wherein said second light source comprises a low-voltage halogen light bulb.

10. The freestanding lamp of claim 7 wherein said second light source comprises an incandescent bulb.

11. The freestanding lamp of claim 2 wherein said second light source is operably connected to said first light source such that when said first light source is illuminated, said second light source is automatically extinguished.

12. The freestanding lamp of claim 2 further comprising a timer operably connected to said second light source such that, upon expiration of said timer, said second light source is automatically extinguished.

13. The freestanding lamp of claim 1 further comprising a simulated control rod extending from the base to the housing giving the appearance that the dimmer switch is contained in the base and that the simulated control rod is operably connected thereto.

14. A freestanding lamp assembly comprising:
a first means for providing a freestanding ability to the assembly;
a second means for creating light;
a third means for elevating the second means above the first means;
a fourth means for varying the intensity of the light created by the second means, the fourth means operably attached to the third means between the first means and the second means.

15. The freestanding lamp assembly of claim 14 further comprising:
a fifth means for creating light, the fifth means operably attached to the third means between the first means and the second means.

16. The freestanding lamp of claim 15 further comprising a sixth means for varying the intensity of the light created by the fifth means, the sixth means operably attached to the third means between the first means and the second means.

17. The freestanding lamp of claim 15 further comprising a means operable to turn the fifth means on when an ambient light level drops below a predetermined level.

18. The freestanding lamp of claim 16 wherein the sixth means comprises a dimmer switch.

19. The freestanding lamp of claim 16 wherein the sixth means comprises a multiple position switch.

20. The freestanding lamp of claim 17 further comprising a seventh means for attaching the sixth means to the third means, the seventh means allowing the sixth means to be moved relative to the third means.

21. The freestanding lamp of claim 20 wherein the seventh means comprises a swing arm.

22. The freestanding lamp of claim 15 wherein the sixth means comprises a night-light.

23. The freestanding lamp of claim 22 wherein the night-light comprises a low-wattage bulb, having an intensity less than that of the second means.

24. The freestanding lamp of claim 22 wherein the night-light comprises a light emitting diode.

25. The freestanding lamp of claim 15 further comprising an eighth means for illuminating the sixth means when the second means is extinguished.
